(19) United States
(12) Patent Application Publication
(10) Pub. No.: US 2018/0275922 A1
(43) Pub. Date: Sep. 27, 2018

(54) Solid State Disk with Consistent Latency

(71) Applicant: Siamack Nemazie, Los Altos Hills, CA (US)

(72) Inventor: Siamack Nemazie, Los Altos Hills, CA (US)

(21) Appl. No.: 15/915,625

(22) Filed: Mar. 8, 2018

Related U.S. Application Data
(60) Provisional application No. 62/477,188, filed on Mar. 27, 2017.

(51) Int. Cl. G06F 3/06; G06F 12/1009

(52) U.S. Cl. CPC G06F 3/0659; G06F 3/0611; G06F 2212/202; G06F 12/1009; G06F 2212/1024; G06F 3/0679

(57) ABSTRACT

A Solid State Disk (SSD) is disclosed to avoid collision of page reads with page program or block erase and thereby provide consistent latency. In one embodiment a group of NVM dies are paired, information programmed only in dies that are paired, and programmed in both dies of the pair, concurrent program or erase of paired dies are avoided, and read from a die that is being programmed or erased is directed to its paired die that is not being programmed or erased.

### FIELD OF THE INVENTION

This invention relates generally to Solid State Disks (SSDs), computer systems and storage systems and having consistent latency and a bandwidth independent of workload.

### BACKGROUND OF THE INVENTION

A solid-state disk (SSD, also known as a solid-state drive) is a storage device that uses non-volatile memory (NVM) to store data persistently. Such non-volatile memory include without limitation NAND flash memory (herein after flash memory), Resistive Random Access Memory (ReRAM), Phase Change Memory (PCM), 3D-XPoint, Magnetic Random Access Memory (MRAM) and Spin Transfer Torque MTAM (STTMRAM). SSDs use input/output (I/O) interfaces for connection to hosts. These I/O interfaces, include Serial AT Attachment (SATA), Serial Attached SCSI (Small Computer System Interface) commonly referred to as SAS and NVM (Non-Volatile Memory) Express commonly referred to as NVMe. To provide higher performance, SSD Interfaces typically support command queueing, in particular SATA, SAS, and NVMe support command queuing.

FIG. 1, shows a prior art exemplary SSDs 90 to include a host bus 30 (such as a SATA, SAS or a PCIe bus), a controller 20, an optional buffer subsystem 40 and a NVM subsystem 50. The controller 20 further including a host interface controller 22, a buffer memory controller 24, a NVM controller 26, and a central processor unit (CPU) subsystem 28. The NVM subsystem 50 is used as persistent storage for storage of data and typically made of non-volatile memory such as flash, ReRAM or 3D-Xpoint. Without loss of generality flash memory will be used as a representative of NVM throughout the disclosure and NVM and flash would be used interchangeably, for example NVM subsystem 50 will be used interchangeably with flash subsystem 50 and NVM controller 26 with flash controller 26. The flash subsystem 50 is shown to include a number of flash memory components or devices (50-1-1 to 50-1-m, . . . 50-n-1 to 50-n-m, “n”, and “m” being integer values) which can be formed from a single semiconductor or die or from a number of such dies. The flash subsystem 50 is shown coupled to the flash controller 26 via flash interface 52. The flash interface 52 includes of one or many flash channels 52-1 to 52-n.

Flash memory is a block-based non-volatile memory where each block includes plurality of pages. A page is the unit of programming in a flash memory. A characteristic of flash memory is that typically programming a page takes ten to thirty times longer than reading a page. A limitation of flash memory is that after a block is programmed, it must be erased prior to being programmed again, that is flash memory does not allow in-place updates. Another limitation of flash memory is that blocks can only be erased for a limited number of times, thus, frequent erase operations reduce the life time of the flash memory.

As mentioned flash memory does not allow in-place updates. That is, it cannot overwrite existing page with new data. The new data are written to erased areas (out-of-place updates), and the old data are invalidated for reclamation in the future. This out-of-place update causes the coexistence of invalid (i.e. outdated) and valid data in the same block. Garbage Collection (G 5 C) is the process to reclaim the space occupied by the invalid data from one or more blocks, by moving valid data to a new block and erasing the old blocks. But garbage collection results in significant performance overhead as well as unpredictable operational latency, as a user read request may collide with garbage cleaning write in the same die. As mentioned, flash memory blocks can be erased for a limited number of times. Wear leveling is the process to improve flash memory lifetime by evenly distributing erases over the entire flash memory.

The management of blocks within systems using flash memory including SSDs, is referred to as flash block management and includes: Logical to Physical Mapping; Defect management for managing defective blocks (blocks that were identified to be defective at manufacturing and grown defective blocks thereafter); Wear leveling to keep program/erase cycle of blocks within a band; Keeping track of free available blocks; and Garbage collection for collecting valid pages from a plurality of blocks (with a mix of valid and invalid page) into one block and in the process creating free blocks. The flash block management requires maintaining various tables referred to as flash block management tables (or “flash tables”). These tables are generally proportional to the capacity of SSD.

A factor that impacts the performance of garbage collection is over-provisioning (OP). The idea of over-provisioning is to provide additional spare capacity (Cs) beyond user capacity (Cu). The Over-provisioning (OP) is defined as spare capacity (Cs) as a percent of user capacity (OP=Cs/Cu). Write Amplification (WA) is the average number of (page) writes per user (page) write due to garbage collection. Write Amplification factor; WAf, is defined as WAf=WA−1.

There are various analytical models for WA. A presentation by T. W. McCormick presented in Flash Memory Summit (FSM) 2016 entitled “Validating Analytic Write Amplification Models” (hereafter “McCormick presentation”) includes some of these models. One model in the presentation attributed to Bux, Bux model, predicts WA=1+1/OP. Another model for WA by Rajiv Agrawal presented in IEEE Globecom 2010 entitled “A closed-form expression for Write Amplification in NAND Flash” that predicts WA=0.5*(1+1/OP). In general, the higher the OP, the lower the WA. The Bux model is the worst case model reported in the McCormick presentation.

SSDs that support command queuing and are based on a non-volatile memory that have significantly longer program time than read access time, such as SSDs based on NAND Flash memory or RRAM, do not provide consistent latency. For example a queued read command exhibits different latency if the target die is busy performing read vs. performing write from an earlier queued command.

SSDs may be performing background operations when host requests access, causing inconsistent performance. Background operation include write back cache, garbage collection and wear leveling. For example when an SSD based on NAND Flash is performing background garbage collection it may cause one or more dies to become busy performing write or erase operation, meanwhile read commands issued by host(s) involving dies busy programming will suffer latencies significantly larger than when dies are idle or busy reading.

Furthermore SSDs do not provide a read/write bandwidth independent of the workload.

Similarly computer systems employing SSDs in general do not provide consistent latency and a read/write bandwidth independent of the workload to the applications and services requiring access to SSDs. Storage systems (such as file servers) serving blocks or files to clients employing SSDs in general do not provide consistent latency to clients.

Providers of computer services such as providers of Cloud based services or providers of Platform as Service (PaaS) need to meet Service Level Agreements (SLAs) committed to clients. Consistent latency and read/write bandwidth and performance guarantees from SSD is one of the pillars of achieving committed SLAs.

What is needed is Solid State Disks (SSDs), computer systems and storage systems having consistent latency providing a read/write bandwidth independent of the workload.

### SUMMARY OF THE INVENTION

Briefly, in accordance with one embodiment of the present invention, a group of NVM memory dies are paired, for all paired dies, one die of a pair is designated as primary die and the other die of the pair is designated as secondary die, data programmed to a die of a pair is also programmed to the corresponding die (of the pair), however, paired dies are not programmed or erased concurrently, and a read from a die that is being programmed or erased is directed to its paired die that is not being programmed or erased, thereby avoiding delaying the read response due to program or erase in progress, providing a read/write bandwidth independent of workload, and recovering from failure of one the blocks of a paired block.

In a variation of the embodiment one or more free blocks of each die (of a paired dies) are also uniquely paired with free blocks of the corresponding die (of the paired dies) forming paired blocks, data is programmed to a block of a pair is also programmed to the corresponding block (of the pair), blocks in a primary die are designated as primary blocks, and the corresponding blocks in a secondary die are designated a secondary blocks, the primary block is programmed first and then the secondary block is programmed and this is repeated. In yet another variation of the above embodiment, the paired blocks and pages are in like position (i.e. same block number).

In yet another variation of the above embodiment when number of free blocks fall below a threshold, a garbage collection process is initiated to create more free blocks wherein garbage collected data programmed in a primary is also programmed to the corresponding secondary, and when a primary block is erased, the corresponding secondary block is also erased and wherein paired dies are not programmed or erased concurrently.

The benefits of the embodiment is achieved at the cost of extra capacity (Ce), the overhead (OH) is the extra capacity (Ce) required beyond (Cu+Cs) as a percentage of (Cu+Cs), that is OH %=100*Ce/(Cu+Cs). The embodiment requires an overhead of 100%. By way of example consider a prior art SSD with a user capacity (Cu) of 256 dies, and OP of 25%, that is overprovisioned capacity (Cs) is 64 dies for a total of 320 dies, then the above embodiment requires an additional 320 dies (Ce=320 dies) for a total of 640 dies, with OH of 100%. Next an embodiment that significantly reduces the overhead will be described.

In another embodiment, not all dies are paired, there is a group of dies that are not paired (also referred to as “unpaired pool”) and there is a group of dies that are paired (also referred to as “paired pool”). The paired and unpaired pools are dynamic in the sense that dies belonging to these pools change over time. One die of a pair is designated as primary die and the other die of the pair is designated as secondary die, one or more free blocks of primary dies are also uniquely paired with free blocks of the corresponding secondary dies, forming paired blocks, blocks in primary die are designated as primary blocks and the corresponding blocks in a secondary die are designated as secondary blocks. Data is programmed to dies that are paired, data programmed in a primary block is also programmed in the secondary block, paired dies are not programmed or erased concurrently, and a read from a die that is being programmed or erased is directed to its paired die that is not being programmed or erased, after the primary die is full or near full (almost all blocks programmed) the secondary die is reclaimed and paired with a free available die to form a new pair, and the primary dies are returned to pool of unpaired dies, thereby avoiding read collision with program or erase in progress, and reducing the extra capacity required compared to the first embodiment. In a version of the above embodiment the paired blocks and pages are in like position.

In another version of the above embodiment the number of pairs is kept the same, say M pairs (M being an integer) and when number of free dies fall below a threshold a process is initiated to garbage collect the used dies in unpaired pool to create free dies. To create M free dies and maintain the bandwidth provided by M dies the garbage collection requires M*WAf dies. In one implementation the method requires a total of (2+WAf)*M additional dies (2*M for paired pool and WAf*M for garbage collection process).

In a yet another version of the above embodiment the primary block is programmed first and then the secondary block is programmed and this is repeated. In preferred embodiment data is programmed concurrently in primary dies and then concurrently in secondary blocks (primary and secondary blocks are not programmed or erased concurrently), thereby providing a number of dies available for concurrent write independent of reads, thereby providing a write bandwidth independent of read bandwidth. The number of pairs M is selected to deliver a desired bandwidth independent of workload.

One measure of bandwidth is MBs (Mega Bytes per second) and another is in terms of IOPS (Input/output operations per second) using 4 KB (Kilo Bytes) block size. By way of example consider an SSD using a flash that delivers about 25 MBs write bandwidth per die, then for the a desired write bandwidth of 400 MBs (100K IOPS) then M is about 16. Using the earlier example of SSD with a user capacity (Cu) of 256 dies, spare capacity (Cs) of 64 dies, OP of 25% (WAf of 4 based on Bux model), then the above embodiment requires an extra capacity Ce of M*(2+WAf)=96 dies for a total of 416 dies. This embodiment requires an overhead of 30% (96/(256+64))=30%) vs. overhead of 100% for the previous embodiment. In this embodiment, the benefit of reduction of overhead is achieved at cost of capping the number of dies available for concurrent write. Next an embodiment that improves the write bandwidth without adverse effect on overhead will be described.

Yet another embodiment is based on adaptively changing M (the number of pairs) based on utilized user capacity. The embodiment is based on the observation that the unutilized user capacity can be used to increase M or OP adaptively.

For example, using the earlier example of SSD with a user capacity (Cu) of 256 dies, spare capacity (Cs) of 64 dies, OP of 25% (WAf of 4 based on Bux model), when the utilized user capacity (Cut) is below 50%, about 128 dies are available, utilizing these available dies would enable doubling the number of M to 32 (with same overhead) and thereby doubling the write bandwidth when user capacity utilization is below 50%.

The embodiment keeps track of utilized capacity and when utilized user capacity is below 50% a first value of M is used and when above 50% a second value is used.

Other embodiment of the adjustment of M based on utilized user capacity are within scope of invention.

In yet another embodiment, the OP and M are adaptively changed based on utilized user capacity to reduce the overall overhead as well as improving the bandwidth. For example, consider the earlier example of SSD with a user capacity (Cu) of 256 dies, spare capacity (Cs) of 64 dies, OP of 25% (WAf of 4 based on Bux model). The embodiment that will be described reduces the Ce from 96 dies to 64 dies, the OH reduced to 20% from 30%, and improves the write bandwidth when the user capacity utilization is less than 75%. In this embodiment, when the utilized user capacity (Cut) is below 50%, about 128 user dies are available which are utilized to change OP to 100% (at Cut of 50%, the OP is 128/128=100%), change WAf to 1, change required extra capacity Ce to (2+WAf)*M=3*M dies, the remaining 128 dies can be used for Ce, thus M can be as high as 42 (round(128/3), round indicates result is rounded to nearest integer). In this embodiment, when the utilized user capacity (Cut) is between 50% and 75%, about 64 user dies are available, which are utilized to change OP to 66.6% (at Cut of 75%, the OP is 128/192=66.6%), change WAf to 1.5, change required extra capacity Ce to (2+WAf)*M=3.5*M dies, the remaining 64 dies can be used for Ce, thus M can be as high as 18 (round(64//3.5)). In this embodiment, when the utilized user capacity (Cut) is 75% or more, no more extra user dies are available to change OP, OP remains at 25% (at Cut of 100% the OP is 64/125=25%) and WAf remains at 4, required extra capacity Ce remains at (2+WAf)*M=6*M dies, the remaining 64 dies can be used for Ce, thus M can be as high as 10 (round(64//6)).

Table 1 below summarizes above and associated values of M and write bandwidth based on overhead of 20% (Ce=64 dies)

TABLE 1

| | | | Dies | |
|---|---|---|---|---|
| | | | available | |
| | | | based | |
| | | Ce | on 20% | |
| Utilized | OP/ | Required | Overhead | |
| Capacity (Cut) | WAf | dies | (64 dies) | M/Write BW |
| Cut <50% | 100%/1 | 3*M | 128 | 42/262K IOPs |
| 50% ≤ Cut < 75% | 66.6%/1.5 | 3.5*M | 64 | 18/112.5K IOPs |
| 75%≤ Cut | 25%/4 | 6*M | 64 | 10/62.5K IOPs |

These and other objects and advantages of the invention will no doubt become apparent to those skilled in the art after having read the following detailed description of the various embodiments illustrated in the several figures of the drawing.

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1 shows an exemplary SSD of prior art.

FIG. 2 shows a pairing of dies and blocks in flash sub-system 100, in accordance with an embodiment of the present invention.

FIG. 3a shows a flash management table 150, in accordance with an embodiment of the present invention.

FIG. 3b shows further details of entry 154 of table 152.

FIG. 3c shows further details of entry 164 of table 162.

FIG. 4a shows a flash management table 170, in accordance with another embodiment of the present invention.

FIG. 4b shows further details of entry 174 of table 172.

FIG. 5 shows process flow of the relevant steps performed in scheduling page writes in accordance with an embodiment of the present invention.

FIG. 6a shows process flow of the relevant steps performed in scheduling page read in accordance with an embodiment of the present invention.

FIG. 6b shows process flow of the relevant steps performed in read recovery in accordance with an embodiment of the present invention.

FIG. 7 shows a pairing of dies and blocks in flash sub-system 300, in accordance with another embodiment of the present invention.

FIG. 8a shows a flash management table 330, in accordance with another embodiment of the present invention.

FIG. 8b shows further details of entry 344 of table 342.

FIG. 8c shows further details of entry 344 of table 342.

FIG. 9a shows process flow of the relevant steps performed in scheduling page writes in accordance with another embodiment of the present invention.

FIG. 9b shows process flow of the relevant steps performed in the sub process to erase the next invalid block.

FIG. 10a shows process flow of the relevant steps performed in the sub process to adjust M in accordance with another embodiment of the present invention.

FIG. 10b shows process flow of the relevant steps performed in the sub process to adjust M in accordance with yet another embodiment of the present invention.

### DETAILED DESCRIPTION OF PREFERRED EMBODIMENTS

As will be evident in the various embodiments of the present invention, a Solid State Disk (SSD) is disclosed to provide consistent latency and bandwidth independent of workload.

The figures are not intended to be exhaustive or to limit the present invention to the precise form disclosed. It should be understood that the invention can be practiced with modification and alteration, and that the disclosed technology be limited only by the claims and equivalents thereof.

In the following description of the embodiments, reference is made to the accompanying drawings that form a part hereof, and in which is shown by way of illustration of the specific embodiments in which the invention may be practiced. It is to be understood that other embodiments may be utilized because structural changes may be made without departing from the scope of the present invention. It should be noted that the figures discussed herein are not drawn to scale and thicknesses of lines are not indicative of actual sizes.

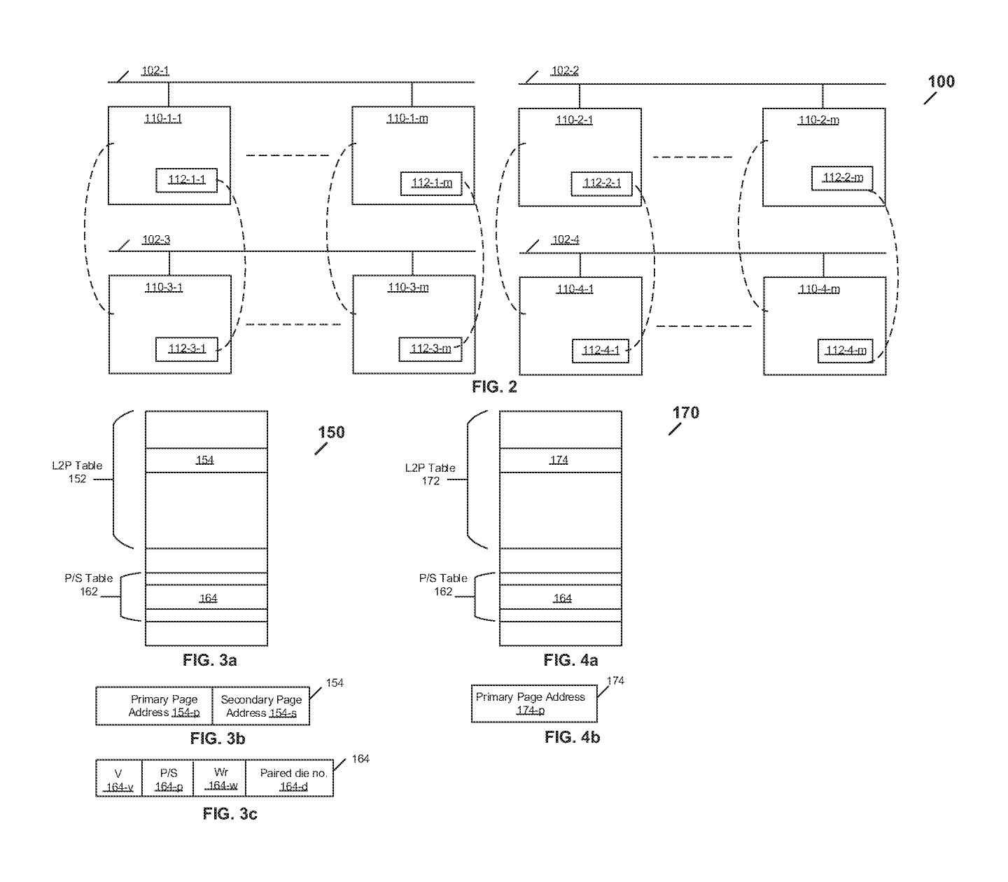

FIG. 2 shows the flash subsystem 100 of an embodiment of the SSD of the present invention to include flash channels 102-1, 102-2, 102-3 and 102-4. Each flash channel 102-k (k=1 to 4) includes a number of flash memory components or devices comprising of flash memory dies 110-k-1 to 110-k-m, (“m” being integer values). One by one flash dies 110-1-1 to 110-1-m are paired with flash dies 110-3-1 to 110-3-m and similarly flash dies 110-2-1 to 110-2-m are paired with flash dies 110-4-1 to 110-4-m. Similarly blocks in paired dies are paired together. Referring to FIG. 2, blocks 112-1-1 to 112-1-m in dies 110-1-1 to 110-1-m are shown to be paired with blocks 112-3-1 to 112-3-m in the paired dies 110-3-1 to 110-3-m, similarly block 112-1-m to 112-2-m in dies 110-2-1 to 110-2-m are shown to be paired with blocks 112-4-1 to 112-4-m in the paired dies 110-4-1 to 110-4-m. Data written to a page of a block in a paired die is also written to a page of the corresponding paired block in the corresponding paired die. Paired dies are not programmed or erased concurrently. One of the paired dies is designated as primary and the corresponding one designated a secondary die. The blocks of a primary die are referred to as primary blocks and the paired blocks in secondary die are referred to as secondary blocks. Data is written to primary block first before being duplicated in the corresponding secondary block.

FIGS. 3a, 3b, and 3c show an embodiment of present invention for maintaining the pairing information shown in FIG. 2, comprising of tables and the corresponding table entries. The tables are stored in the buffer subsystem 40. In other embodiments all or some of the tables may be stored in Random Access Memory (RAM) in the controller 20, such as CPU RAM 28-2 or other RAM (not shown).

FIG. 3a shows a flash management table 150, in accordance with an embodiment of the invention. For example, the table 150 is shown to include a logical address-to-physical address table (also referred to as “L2P table”) 152, and a primary/secondary table (also referred to as “P/S table”) 162.

The L2P table 152 maintains an entry 154 corresponding to the logical page address. The logical page address is the index into the L2P table 152.

Referring to FIG. 3b, entry 154 corresponding to logical page address is shown to include the flash page address in primary block 154-p and flash page address in secondary block 154-s.

The P/S table 162 maintains an entry 164 corresponding to a die. The die number is the index into the P/S table 162.

Referring to FIG. 3c, entry 164 corresponding to a die is shown to include fields for flag V 164-v, flag P/S 164-p, flag Wr 164-w and a field for the die number of the corresponding paired die 164-d.

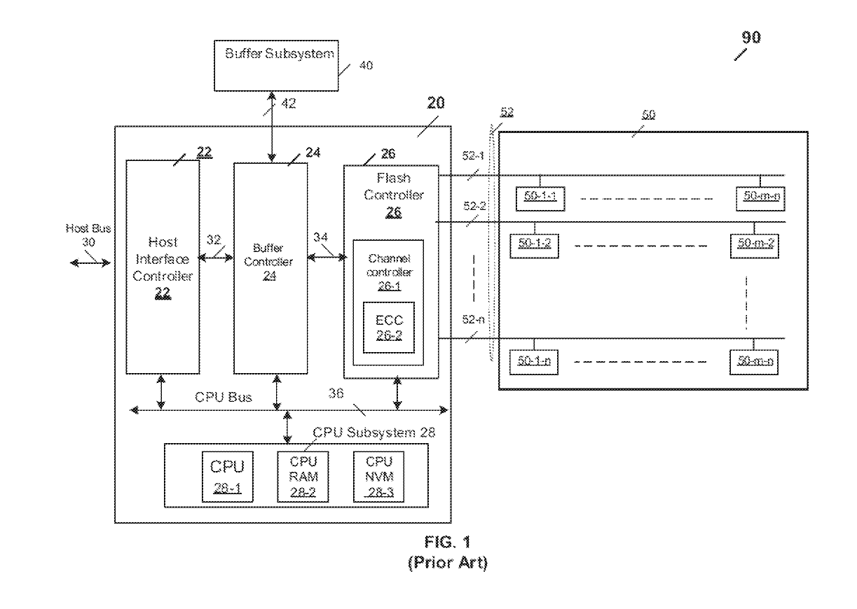

The flag V 164-v is optional and when set indicates that the entry 164 is valid and when the flag reset indicates that the entry is not valid. The flag P/S 164-p is used to indicate whether the die is primary or secondary. When the flag P/S is set it indicates that the die is a primary die and when the said flag is reset it indicates that the die is a secondary die. The flag Wr 164-w is used to indicate whether the die is busy or will be busy performing a program or erase or not. When the flag 164-w is set it indicates that die is busy or will be busy performing a program or an erase. The CPU subsystem 28 (as shown in FIG. 1) sets the flag Wr 164-w prior to initiating or scheduling a program or erase of the die, and resets the flag Wr 164-w after completion of program or erase.

When a read page is being processed the CPU subsystem 28 (as shown in FIG. 1) checks the flag Wr 164-w associated with the primary flash address 154-p, if said flag is set then the secondary flash address 154-s is used for reading the page from secondary die else the primary flash address is used for reading the page from primary die, thereby avoiding read from a die that is being programmed or erased.

FIGS. 4a, and 4b show another embodiment of present invention for maintaining the pairing information shown in FIG. 2, comprising of tables and the corresponding table entries. The tables are stored in the buffer subsystem 40. FIG. 4a shows a flash management table 170, in accordance with an embodiment of the invention. For example, the table 170 is shown to include a logical address-to physical address table (also referred to as “L2P table”) 172, and a primary/secondary table (also referred to as “P/S table”) 162 described earlier.

The L2P table 172 maintains an entry 174 corresponding to the logical page address. The logical page address is the index into the L2P table 172.

Referring to FIG. 4b, entry 174 corresponding to logical page address is shown to include only the flash page address in primary block 174-p. In this embodiment the paired block in secondary die is in like position as the primary, and pages are in like position as well, thereby the secondary page address can be formed from primary page address by replacing the primary die number with the paired secondary die number (the block number and the page number is the same). When a flash page read is being processed, the CPU subsystem 28 (as shown in FIG. 1) checks the flag Wr 164-w associated with the primary flash address 174-p, if said flag is set then the secondary page address is formed as described above by replacing the primary die number with the paired secondary die number and used for reading the page from secondary die else the primary flash address is used for reading the page from primary die, thereby avoiding read from a die that is being programmed or erased.

In case any of the paired blocks is defective or becomes defective an alternate bock is assigned by defect management. A prior art defect management schemes can be used to substitute a defective block.

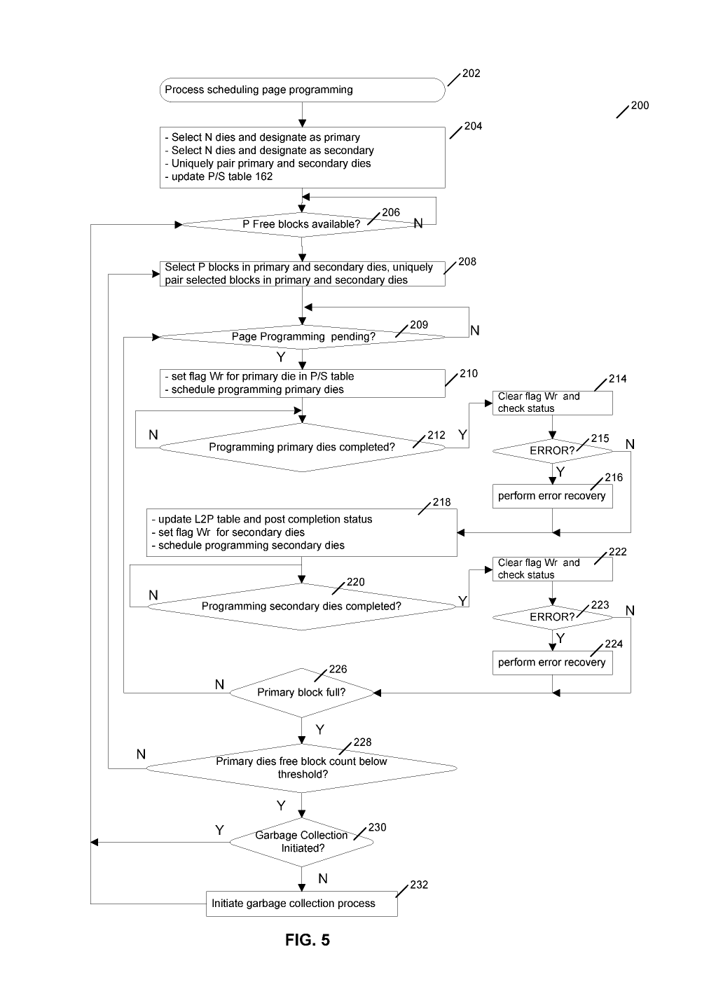

FIG. 5 shows a process flow 200 of the relevant steps performed in scheduling page programming using the embodiments shown and discussed above and in accordance with a method of the present invention. The steps of FIG. 5 are generally performed by the CPU subsystem 28 of the SSD 90 of FIG. 1.

In FIG. 5, at step 204, N (where “N” is an integer) dies are selected and designated as primary dies, and another N dies are selected and designated as secondary dies, the primary and secondary dies are uniquely paired, and P/S table 162 is updated accordingly.

Next, at step 206, a determination is made of whether or not P (where “P” is an integer) free blocks is available in primary and secondary dies for active blocks (which is the case on transition from step 204 to step 206) and if not, the process waits for the availability of P free blocks, otherwise, the process continues to step 208.

The active blocks of a die are blocks that are being programmed concurrently. In one embodiment P is the number of blocks required for various processes performing programming (such as user write and garbage collection). In another embodiment user write and garbage collection processes share one block (that is P=1), and in another embodiment user write and garbage collection processes require more blocks.

Next at step 208, P blocks in primary and secondary dies are selected and uniquely paired together, the process continues to step 209. Next at step 209 a determination is made if a flash page programming is pending and if not, the process waits at step 209 until there is a pending page programming, otherwise, the process continues to step 210.

At step 210, the flag Wr is set in P/S table 162 for the primary dies with a pending programming and then programming is scheduled in channel controller 26.

Next, at step 212, a determination is made of whether or not the programming of step 210 is completed and if not, process remains in step 212 until the completion of programming, otherwise, the process continues to step 214.

At step 214, flag Wr is cleared for primary dies and the status of flash programming is checked, the process continues to step 215. At step 215 a determination is made if flash page programming was successful, if not process continues to step 216, otherwise the process continues to step 218. At step 216, error recovery from programming error is performed and then the process continues to step 218.

At step 218, the L2P table 172 is updated, the entry 174-p corresponding to the logical page is updated, and a completion status is posted, the flag Wr is set in P/S table 162 for the corresponding secondary dies with a pending programming and then programming is scheduled in channel controller.

Next, at step 220, a determination is made of whether or not the programming of step 218 is completed and if not, process remains in step 220 until the completion of programming, otherwise, the process continues to step 222.

At step 222, flag Wr is cleared for secondary dies and the status of flash programming is checked, the process continues to step 223. At step 223, a determination is made if flash page programming was successful, if not process continues to step 224, otherwise the process continues to step 226. At step 224, error recovery from programming error is performed and then the process continues to step 226.

At step 226, a determination is made if the primary active blocks are full, if not the process continues to step 209, otherwise, the process continues to step 228. At step 228, a determination is made if the free block count of the primary dies is below a first threshold, and if not the process continues to step 208, otherwise, the process continues to step 230. At step 230, a determination is made if garbage collection has been initiated, and if not the process continues to step 232, otherwise, the process continues to step 206.

At step 232, garbage collection is initiated to increase the number of free blocks to a second threshold, and the process continues to step 206.

Steps 206, 209, 212 and 220 are performed by “polling”, known to those in the art, alternatively, rather than polling, an interrupt routine is used in response to completion of tasks. The alternative and other methods, known to those in the art, fall within the scope of invention.

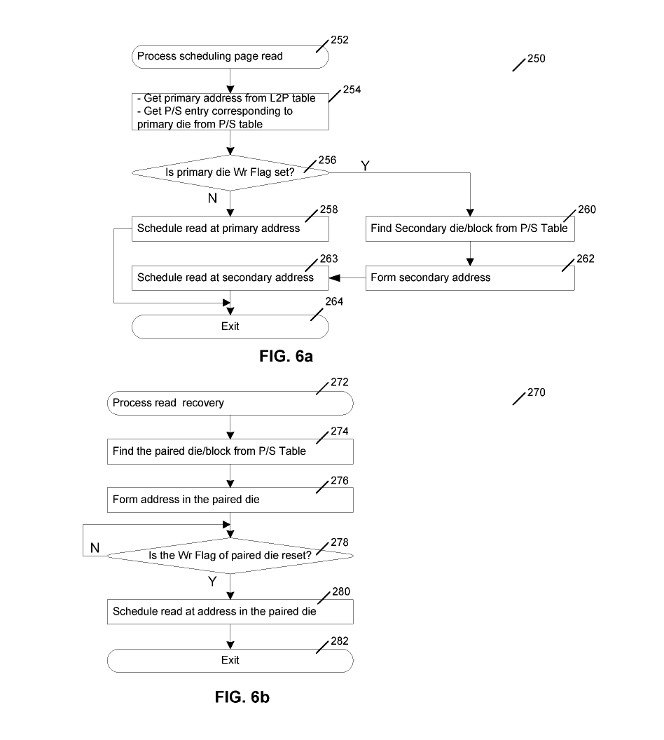

FIG. 6a shows a process flow 250 of the relevant steps performed in scheduling page reads using the embodiments shown and discussed above and in accordance with a method of the invention. The steps of FIG. 6a are generally performed by the CPU subsystem 28 of the SSD 90 of FIG. 1.

At step 254, the logical page address is used as index into L2P table 172 to obtain the primary page address 174-p. The primary die number is extracted from the primary page address and used as index into P/S table 162, to obtain the P/S entry 164 corresponding to the primary die. The process continues to step 256.

At step 256, a determination is made if the flag Wr 164-w in P/S entry 164 is set, if not the process continues to step 258, otherwise, the process continues to step 260. At step 258, a page read is scheduled at primary page address in the flash channel controller 26, and the process continues to step 264 and exits. At step 260, the secondary die number which is the paired die number 164-d in P/S entry 164 is obtained, and the process continues to step 262. At step 262 the secondary page address in secondary die is formed and the process continues to step 263. At step 263, a page read is scheduled at secondary page address in the flash channel controller 26, and the process contuse to step 264 and exits.

FIG. 6b shows a process flow 270 of the relevant steps performed in scheduling a read recovery using the embodiments shown and discussed above and in accordance with a method of the present invention. The steps of FIG. 6b are generally performed by the CPU subsystem 28 of the SSD 90 of FIG. 1.

At step 274, the paired die number 164-d in P/S entry corresponding to the die with read error is obtained. The process continues to step 276. At step 278, the flash page address of paired die is formed by substituting paired die number 164-d for the die number in the page address, and the process continues to step 278.

At step 278, a determination is made if the flag Wr 164-w in P/S entry 164 corresponding to paired die is reset, if not the process waits in step 278, otherwise, the process continues to step 280. At step 280, a page read is scheduled at paired die page address in the flash channel controller 26, and the process continues to step 282 and exits. If the scheduled read is successful the read recovery is successful, otherwise the completion status would indicate error.

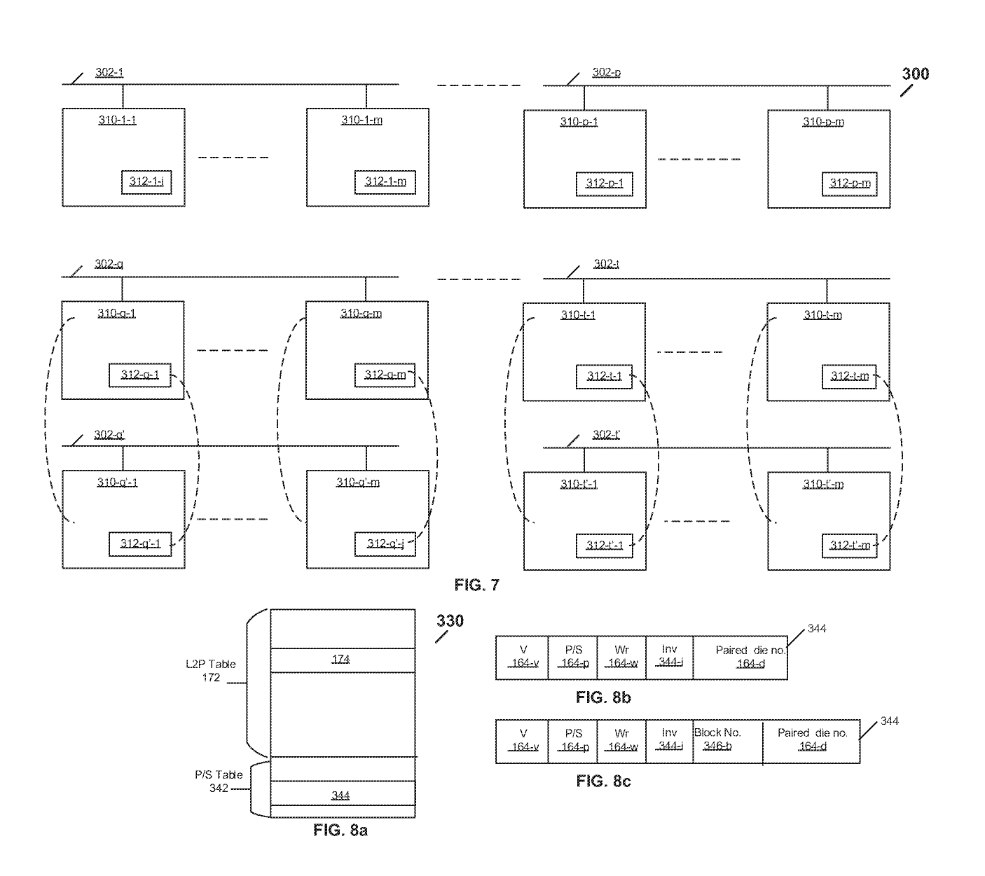

FIG. 7 shows the flash subsystem 300 of an embodiment of the SSD of the present invention to include flash channels 302-1 to 302-p, 302-q to 302-t and 302-q′ to 302-t′. Each said flash channel 302-k (where k is from 1 to p, q to t and q′ to t′) includes a number of flash memory components or devices comprising of flash memory dies 310-k-1 to 310-k-m, (where k is from 1 to p, q to t and q′ to t′ and “m” being integer values).

One by one flash dies 310-q-1 to 310-q-m are paired with flash dies 310-q′-1 to 310-q′-m and similarly flash dies 310-t-1 to 310-t-m are paired with flash dies 310-t′-1 to 310-t′-m. Similarly blocks in paired dies are paired together. Referring to FIG. 7, blocks 312-q-1 to 312-q-m in dies 310-q-1 to 310-q-m are shown to be paired with blocks 312-q′-1 to 312-q′-m in the paired dies 310-q′-1 to 310-q′-m, similarly block 312-t-1 to 312-t-m in dies 310-t-1 to 310-t-m are shown to be paired with blocks 312-t′-1 to 312-t′-m in the paired dies 310-t′-1 to 310-t′-m. Data written to a page of a block in a paired die is also written to a page of the corresponding paired block in the corresponding paired die. Paired dies are not programmed or erased concurrently. One of the paired dies is designated as primary and the corresponding one designated a secondary die. The blocks of a primary die are referred to as primary blocks and the paired blocks in secondary die are referred to as secondary blocks. Data is written to primary block first before being duplicated in the corresponding secondary block. Note that dies 310-k-1 to 310-k-m on flash channels 302-k (k is an integer from 1 to p) and their corresponding blocks are not paired. The group (or pool) of dies that are paired is dynamic that is the dies belonging to the group (or pool) change over time. Similarly the group (or pool) of dies that are not paired (also referred to as unpaired pool) is dynamic. After the primary dies of a group of paired dies are full (all pages written) or near full, the corresponding secondary dies are invalidated and the primary dies returned to the unpaired pool, and the invalidated secondary dies returned to the pool of available dies (a flag is set for the invalidated dies to indicate that blocks are not erased), and paired with same number of free blocks to form a new paired pool.

FIGS. 8a, 8b and 8c show an embodiment of the present invention for maintaining the pairing information shown in FIG. 7, comprising of tables and the corresponding table entries. The tables are stored in the buffer subsystem 40. In other embodiments all or some of the tables may be stored in Random Access Memory (RAM) in the controller 20, such as CPU RAM 28-2 or other RAM (not shown).

FIG. 8a shows a flash management table 330, in accordance with an embodiment of the present invention. For example, the table 330 is shown to include a logical address-to-physical address table (also referred to as “L2P table”) 172, and a primary/secondary table (also referred to as “P/S table”) 342. The L2P table 172, and L2P table entry 174 was previously described in regards to FIGS. 4a and 4b.

The P/S table 342 maintains an entry 344 corresponding to every die. The die number is the index into the P/S table 342.

Referring to FIG. 8b, entry 344 corresponding to a die is shown to include fields for flag V 164-v, flag P/S 164-p, flag Wr 164-w and a field for the die number of the corresponding paired die 164-d, which were described previously with regard to FIG. 3c. Additionally entry 344 includes a new field for flag Inv 344-i.

The flag Inv 344-i is used to indicate that the blocks of this die are invalid. When the flag Inv 344-i is set it indicates that all or some blocks of the die are invalid and can be erased.

Referring to FIG. 8c, another embodiment of entry 344 is shown to include a field Block No. 346-d in addition to the fields in the embodiment of FIG. 8b. In this embodiment when flag Inv 344-I is set then Block No 346-b is used to indicate the next block to be erased. Invalid blocks are erased from first block number to the last block number of die.

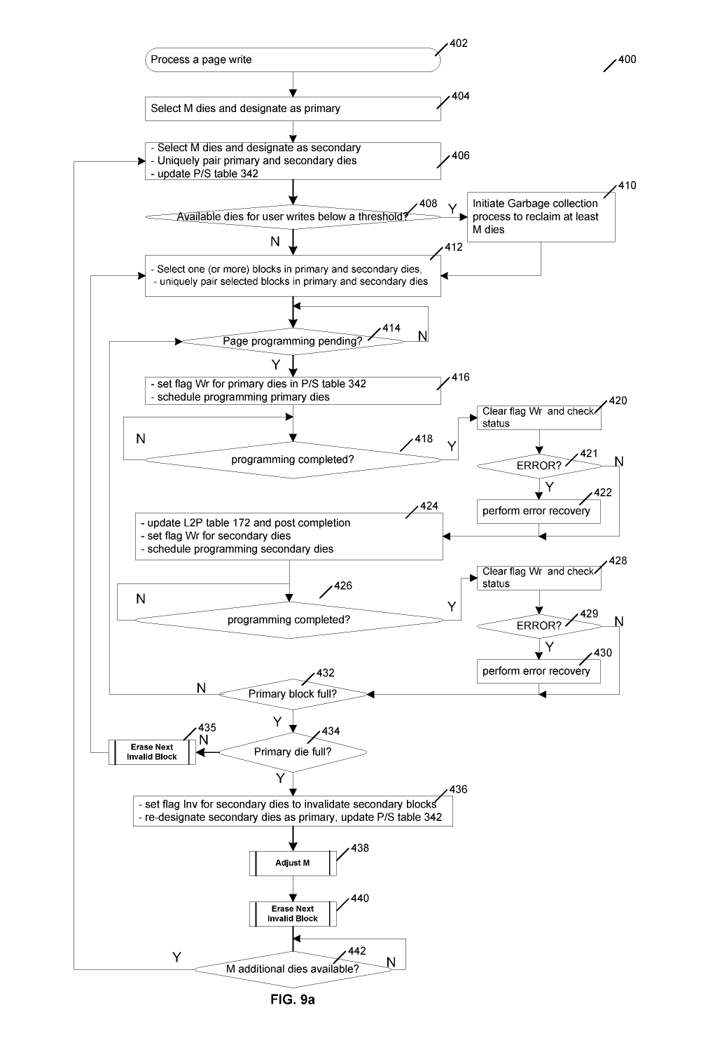

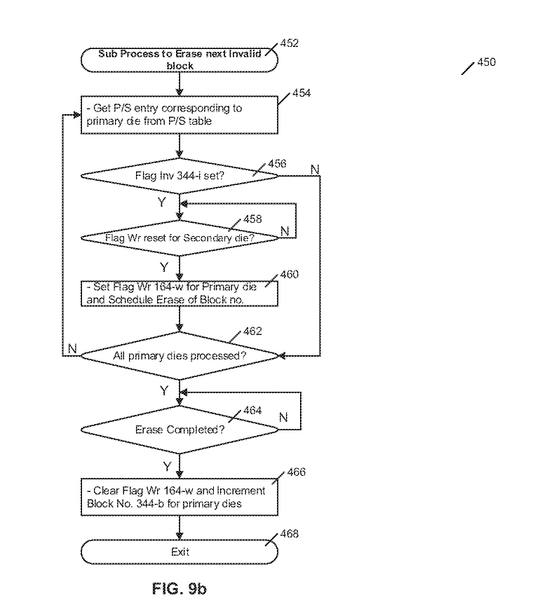

FIG. 9a shows a process flow 400 of the relevant steps performed in write operation including scheduling page writes using the embodiments shown in FIGS. 7, 8a, 8b, and 8c and discussed above and in accordance with a method of the present invention. The steps of FIG. 9a are generally performed by the CPU subsystem 28 of the SSD 90 of FIG. 1.

In FIG. 9a, at step 404, M (here “M” is an integer) dies are selected and designated as primary dies. Next, at step 406, another M dies are selected and designated as secondary dies, the primary and secondary dies are uniquely paired, and P/S table 342 is updated accordingly and the process continues to step 408.

Next, at step 408, a determination is made of whether or not available dies for user write are below a threshold (in one embodiment if additional M (where “M” is an integer) dies are available) and if not, the process continues to step 412, otherwise, the process continues to step 410. At step 410, Garbage Collection (also referred to as “GC”) is initiated and the process continue to step 412.

Next at step 412, blocks in primary dies are selected and uniquely paired with blocks in like position in the secondary dies, and the process continues to step 414. Next at step 414 a determination is made if a flash page programming is pending and if not, the process waits at step 414 until there is a pending page programming, otherwise, the process continues to step 416.

At step 416, the flag Wr is set in P/S table 342 for the primary dies with a pending programming and then programming is scheduled in channel controller 26.

Next, at step 418, a determination is made of whether or not the programming of step 416 is completed and if not, process remains in step 418 until the completion of programming, otherwise, the process continues to step 420.

At step 420, flag Wr is cleared for primary dies and the status of flash programming is checked, the process continues to step 421. At step 421, a determination is made if flash page programming was successful, if not process continues to step 422, otherwise the process continues to step 424. At step 422, error recovery from programming error is performed and then the process continues to step 424.

At step 424, the L2P table 172 is updated, the entry 174-p corresponding to the logical page is updated, and a completion status is posted, the flag Wr is set in P/S table 342 for the corresponding secondary dies with a pending programming and then programming is scheduled in channel controller 26.

Next, at step 426, a determination is made of whether or not the programming of step 424 is completed and if not, process remains in step 426 until the completion of programming, otherwise, the process continues to step 428.

At step 428, flag Wr is cleared for secondary dies and the status of flash programming is checked, the process continues to step 429. At step 429, a determination is made if flash page programming was successful, if not process continues to step 430, otherwise the process continues to step 432. At step 430, error recovery from programming error is performed and then the process continues to step 432.

At step 432, a determination is made if the primary active blocks are full, if not the process continues to step 414, otherwise, the process continues to step 434. At step 434, a determination is made if the primary die is full, and if not the process continues to step 435, otherwise, the process continues to step 436. At step 435 a sub-process is called to Erase the next invalid block, after return from the sub-process the main process continues to step 412. At step 436 the flag Inv for secondary dies is set to invalidate the secondary dies, and the Block No. 344-b is set to zero pointing to first block to be erased, the secondary dies are re-designated as primary and the P/S table 342 is updated accordingly, and the process continues to step 438. Step 438 is for embodiments that adjust M (and optionally OP) dynamically, a sub process is called to adjust M, after return from the sub process the main process continues to step 440. At step 440 a sub-process is called to Erase the next invalid block, after return from the sub-process the main process continues to step 442. At step 442, a determination is M additional dies are available, and if not the process waits at step 442 until M additional dies are available, otherwise, the process continues to step 406.

Steps 414, 418, 2426 and 438 are performed by “polling”, known to those in the art, alternatively, rather than polling, an interrupt routine is used in response to completion of the tasks. The said alternative and other methods, known to those in the art, fall within the scope of invention.

FIG. 9b shows a process flow 450 of the relevant steps performed in sub-process to “Erase Next Invalid Block” used in steps 435 and 440 of process 400 described above and in accordance with a method of the invention. The steps of FIG. 9b are generally performed by the CPU subsystem 28 of the SSD 90 of FIG. 1.

At step 454, the P/S entry 344 corresponding to primary die in P/S table 342 is obtained. Next at step 456 a determination is made if the flag Inv 344-i is set for the primary die, and if not the process continues to step 462, otherwise, the process continues to step 458. Next at step 458 a determination is made if the flag Wr 164-w is reset for the corresponding secondary die, and if not the process waits until the flag Wr 164-w is cleared for the corresponding secondary die, otherwise, the process continues to step 460.

Next at step 460 the flag Wr 164-w is set for the primary die and block no. 344-b in the primary die is scheduled for erase in the channel controller 26. Next at step 462 a determination is made if all primary dies are processed, and if not the process continues to step 454 to repeat steps 454 to 462 for next primary die, otherwise the process continues to step 464. At step 464 a determination is made if the scheduled erases in the primary dies are completed, and if not the process waits until all scheduled erases are completed, otherwise the process continues to step 466. At step 466 the Flag Wr 164-w is cleared and block No 344-b is incremented for the primary dies that erase was schedules, and the process continues to step 468 and exits.

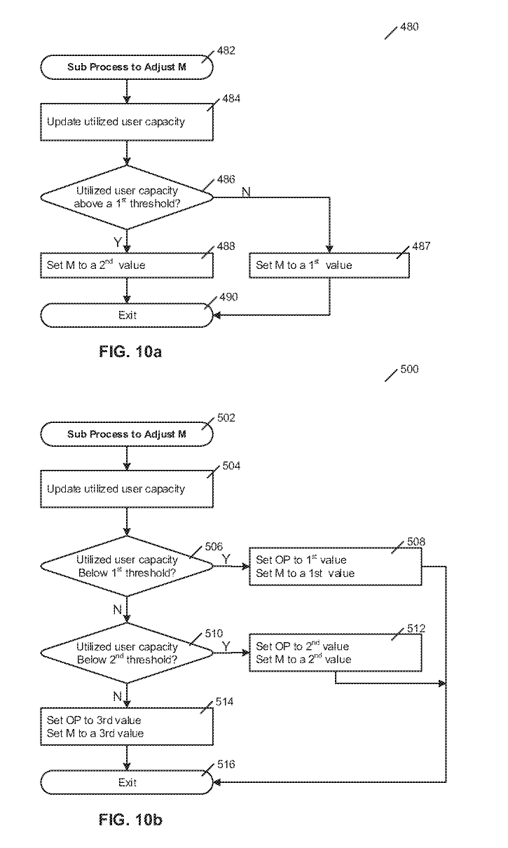

FIG. 10a shows process flow 480 of the relevant steps performed in the sub process to “adjust M” in step 438 of process 400 described above and in accordance with a method of the invention. The steps of FIG. 10a are generally performed by the CPU subsystem 28 of the SSD 90 of FIG. 1.

At step 484, the utilized user capacity is updated. At step 486 a determination is made if the utilized user capacity is equal or above a 1st threshold, if not the process continues to step 487, otherwise the process continues to step 488. At step 487 the value of M is set to a 1st value and sub process 480 exists. At step 488 the value of M is adjusted a 2nd value and the sub process 480 exits.

Other embodiment of the adjustment of M based on utilized user capacity are within scope of invention. By way of example consider adjustment of M based on capacity increments of 25%, when the utilized user capacity (Cut) is below 25% a first value of M is used, when utilized user capacity between 25% and 50% (25%≤Cut<50%) a second value of M is used, when utilized user capacity between 50% and 75% (50%≤Cut<75%) a third value of M is used and when utilized user capacity is a (75%≤Cut) a fourth value of M is used.

FIG. 10b shows process flow 500 of the relevant steps performed in the sub process to “adjust M” in step 438 of process 400 described above and in accordance with yet another method of the invention. The steps of FIG. 10b are generally performed by the CPU subsystem 28 of the SSD 90 of FIG. 1. In this embodiment both M and Op are adjusted dynamically.

At step 504, the utilized user capacity is updated. At step 506 a determination is made if the utilized user capacity is below a 1st threshold in one embodiment 50%, if not the process continues to step 510, otherwise the process continues to step 508. At step 508 the value of OP is set to a 1st value of OP, 100% in this embodiment, and the value M is set to a 1st value of M and sub process 500 exists.

At step 510 a determination is made if the utilized user capacity is below a 2^{nd} threshold, 75% in this embodiment, if not the process continues to step 514, otherwise the process continues to step 512. At step 512 the value of OP is set to a 2nd value of OP, 66.6% in this embodiment, and the value M is set to a 2nd value of M and sub process 500 exists. At step 514 the value of OP is set to a 3rd value of OP, 25% in this embodiment, and the value M is set to a 3rd value of M and sub process 500 exists. Table 2 summarized the 1st, 2nd and 3rd values of OP and M in this embodiment.

TABLE 2

| | | M |
|---|---|---|
| Utilized | | based on 20% overhead |
| Capacity (Cut) | OP | (64 dies) |
| Cut <50% | 1^{st} Value of OP = 100% | 1^{st} Value of M = 42 |
| 50% ≤ Cut < 75% | 2^{nd} Value of OP 66.6% | 2^{nd} Value of M = 18 |
| 75%≤ Cut | 3^{rd} Value of OP = 25% | 3^{rd} Value of M = 10 |

Other embodiment of the dynamic adjustment of OP (overprovisioning) and M (paired pool size) based on utilized user capacity are within scope of invention. Although the invention has been described in terms of specific embodiments using flash NAND memory, it is anticipated that alterations and modifications thereof using similar persistent memory such as Resistive RAM (ReRAM) will no doubt become apparent to those skilled in the art. It is therefore intended that the following claims be interpreted as covering all such alterations and modification as fall within the true spirit and scope of the invention.

Although the invention has been described in terms of specific embodiments, it is anticipated that alterations and modifications thereof will no doubt become apparent to those skilled in the art. It is therefore intended that the following claims be interpreted as covering all such alterations and modification as fall within the true spirit and scope of the invention.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

What is claimed is:

1) A solid state storage device (SSD) configured to store data from a host, said SSD comprising:
a storage subsystem comprising of a plurality of non-volatile memory (NVM) devices with each said NVM device formed from one or more NVM dies, wherein said storage subsystem configured to pair said NVM dies forming a set of paired NVM dies, and further configured to program data in each said paired NVM die, wherein a duplicate of said data programmed in one NVM die is non-concurrently programmed to its corresponding pair, and
wherein a host read data from said SSD from an NVM die that is being programmed or erased is directed to its paired NVM die that is not being programmed or erased, and thereby read collision with a programming process or an erasing process is avoided, and thereby a provided bandwidth of said SSD is independent of a workload.

2) (canceled)

3) The solid state storage device (SSD) of claim 1, wherein each said paired NVM die comprises of a primary die and a secondary die, and wherein said storage subsystem is configured to reclaim said secondary die once said primary die is full, thereby reducing a storage overhead.

4) The solid state storage device (SSD) of claim 1, wherein the number of paired NVM dies is kept close to a constant.

5) The solid state storage device (SSD) of claim 1, wherein the number of paired NVM dies is periodically adjusted to a value based on a utilized capacity dedicated to a storing user data.

6) The solid state storage device (SSD) of claim 1, wherein an overprovisioned capacity is periodically adjusted to a value based on a utilized capacity dedicated to a storing user data.

7) A method of managing a solid state storage device (SSD) having a plurality of non-volatile memory (NVM) devices formed from a plurality of NVM dies, said method comprising:
pairing said plurality of NVM dies to form a set of paired NVM dies;
non-concurrently programming data to both NVM dies of each said paired NVM dies, avoiding concurrent program or erase of said paired NVM dies, and
directing read from an NVM die that is being programmed or erased to its paired NVM die that is not being programmed or erased,
thereby read collision with a programming process or an erasing process is avoided, and thereby a provided bandwidth of said SSD is independent of a workload.

8) The method of claim 7, wherein for all paired NVM dies, one NVM die of a pair is designated as primary die and the other NVM die of the pair is designated as secondary die, and wherein upon a primary die becoming full, the corresponding secondary die is invalidated and reclaimed for reuse, thereby reducing the storage overhead.

9) The method of claim 7, wherein the number of paired NVM dies is kept close to a constant.

10) The method of claim 7, wherein the number of paired NVM dies is periodically adjusted to a value based on a utilized capacity dedicated to a storing user data.

11) The method of claim 7, wherein an overprovisioned capacity is periodically adjusted to a value based on a utilized capacity dedicated to a storing user data.

12) A solid state storage device (SSD) configured to store data from a host, the SSD comprising:
a storage subsystem comprising of a plurality of non-volatile memory (NVM) devices with each said NVM device formed from one or more NVM dies, wherein said storage subsystem configured to pair a group of NVM dies forming a set of paired NVM dies, and further configured to program data only in an NVM die that is paired and further configured to program said data in a corresponding paired NVM die, wherein said set of paired NVM dies are not programmed or erased concurrently, and read from a die that is being programmed or erased is directed to its paired die that is not being programmed or erased, and thereby read collision with a programming process or an erasing process is avoided, and thereby a provided bandwidth of said SSD is independent of a workload.

13) The solid state storage device (SSD) of claim 12, wherein each said paired NVM die comprises of a primary die and a secondary die, and wherein said storage subsystem is configured to reclaim said secondary die once said primary die is full, thereby reducing a storage overhead.

14) The solid state storage device (SSD) of claim 12, wherein the number of paired NVM dies is kept close to a constant.

15) The solid state storage device (SSD) of claim 12, wherein the number of paired NVM dies is periodically adjusted to a value based on a utilized capacity dedicated to a storing user data.

16) The solid state storage device (SSD) of claim 12, wherein an overprovisioned capacity is periodically adjusted to a value based on a utilized capacity dedicated to a storing user data.
